(19) United States
(12) Patent Application Publication
(10) Pub. No.: US 2014/0073169 A1
(43) Pub. Date: Mar. 13, 2014

(54) RECEPTACLE CONNECTOR

(71) Applicant: ADVANCED-CONNECTEK INC., Taipei (TW)

(72) Inventors: FU-YI XU, Taipei (TW); WEI WAN, Taipei (TW); SHU-LIN DUAN, Taipei (TW); Ching-Tien CHEN, Taipei (TW)

(73) Assignee: ADVANCED-CONNECTEK INC., Taipei (TW)

(21) Appl. No.: 14/025,106

(22) Filed: Sep. 12, 2013

(30) Foreign Application Priority Data
Sep. 12, 2012 (CN) 201210335987.3

(51) Int. Cl. H01R 13/6461

(52) U.S. Cl. CPC H01R 13/6461
USPC 439/345

(57) ABSTRACT

A receptacle connector, for being inserted by a plug connector and contacted with a casing of the plug connector, includes a housing, a plurality of elastic pieces and a plurality of auxiliary fastening members. The housing includes a plurality of first surfaces and a plurality of second surfaces. The second surfaces are connected to two ends of the first surfaces so as to form an inserting window. The elastic pieces are disposed on the first surfaces. The auxiliary fastening members are disposed on the first surfaces. Each auxiliary fastening member includes a contacting portion formed extendedly at an inner side of the inserting window. When the contacting portions connected with the casing, the contact area between the casing and the auxiliary fastening members can be increased by the contacting portions so as to reduce the contact resistance between the plug connector and the receptacle connector.

### CROSS-REFERENCES TO RELATED APPLICATIONS

This non-provisional application claims priority under 35 U.S.C. §119(a) on Patent Application No. 201210335987.3 filed in China, P.R.C. on Sep. 12, 2012, the entire contents of which are hereby incorporated by reference.

### BACKGROUND

1. Technical Field

The disclosure relates to a receptacle connector, and particularly relates to a receptacle connector in which the contact resistance is reduced.

2. Related Art

Using an electric apparatus, such as a notebook, is a very common daily experience. Along with the tendency of thinning and lightening, the occupied volume of the receptacle connector on the electric apparatus should also be reduced; however, upon reducing the volume of the receptacle connector, the signal interference issue caused by the electromagnetic interference of the receptacle connector should also be considered.

Additionally, in order to increase the transmitting speed significantly, the number of the conducting terminals of the receptacle connector has to be increased and the conducting terminals have to be arranged densely, so that the signal interferences, such as electrostatic interference, electromagnetic interference, impedance matching, noise interference, crosstalk between adjacent conducting terminals and so forth, are raised quite easily upon transmitting high frequency signals when the distance between two adjacent conducting terminals is too closer or when the terminals are bent or twisted.

A conventional receptacle connector has fool-proofing elastic pieces. When a plug connector is inserted to the conventional receptacle connector, the elastic pieces are contacted with the housing of the conventional receptacle connector for grounding. However, the contact area between the casing of the plug connector and the housing of the receptacle connector is not large enough to reduce the contact resistance between the plug connector and the conventional receptacle connector and to reduce the electromagnetic interference of the conventional receptacle connector.

Therefore, improving the design of the housing of the conventional receptacle connector to reduce the contact resistance between the plug connector and the conventional receptacle connector and to reduce the electromagnetic interference of the conventional receptacle connector, is an important issue.

### SUMMARY

In view of this, the disclosure proposes a receptacle connector so as to reduce the contact resistance between the plug connector and the receptacle connector and to reduce the electromagnetic interference.

One invention concept of the disclosure proposes a receptacle connector, which is provided for being inserted by a plug connector and contacted with a casing of the plug connector, and the receptacle connector includes a housing, a plurality of elastic pieces and a plurality of auxiliary fastening members. The housing includes a plurality of first surfaces and a plurality of second surfaces. The second surfaces are connected to two ends of the first surfaces so as to form an inserting window. The elastic pieces are disposed on the first surfaces. The auxiliary fastening members are disposed on the first surfaces. A first interval is defined between the auxiliary fastening members and the second surfaces. A second interval is defined between the auxiliary fastening members and the elastic pieces. Each auxiliary fastening member includes a contacting portion formed extendedly at an inner side of the inserting window. When the contacting portions connected with the casing, the contact area between the casing and the auxiliary fastening members can be increased by the contacting portions so as to reduce the contact resistance between the plug connector and the receptacle connector.

According to the disclosure, the auxiliary fastening members are disposed on the four corners of the inserting window of the housing, and the contacting portions of auxiliary fastening members are applied to connect with the surface of the casing of the plug connector so as to increase the contact area, reduce the contact resistance and further decrease the electromagnetic interference of the receptacle connector. In addition, the auxiliary fastening members are provided for guiding the inserting orientation of the plug connector so as to prevent the elastic pieces of the receptacle connector from damage when the plug connector is abnormally inserted into the receptacle connector, so that the sustainability and the stability of the receptacle connector upon inserting into/pulling out the plug connector are guaranteed.

The detailed features and advantages of the disclosure are described below in great detail through the following embodiments; the content of the detailed description is sufficient for those skilled in the art to understand the technical content of the disclosure and to implement the disclosure there accordingly. Based upon the content of the specification, the claims, and the drawings, those skilled in the art can easily understand the relevant objectives and advantages of the disclosure.

### BRIEF DESCRIPTION OF THE DRAWINGS

The disclosure will become more fully understood from the detailed description given herein below for illustration only, and thus not limitative of the disclosure, wherein:

FIG. 1 is a perspective view of a receptacle connector of the disclosure;

FIG. 2 is an exploded view of the receptacle connector of the disclosure;

FIG. 3 is a front view of the receptacle connector of the disclosure;

FIG. 4 is a rear view of a housing of the receptacle connector of the disclosure;

FIG. 5 is a perspective view (1) of an auxiliary fastening member of the receptacle connector of the disclosure;

FIG. 6 is a perspective view (2) of the auxiliary fastening member of the receptacle connector of the disclosure;

FIG. 7 is a perspective view (3) of the auxiliary fastening member of the receptacle connector of the disclosure;

FIG. 8 is a perspective view (4) of the auxiliary fastening member of the receptacle connector of the disclosure;

FIG. 9 is a lateral cross-sectional view for showing a plug connector is going to insert into the disclosure; and

FIG. 10 is a lateral cross-sectional view for showing the plug connector is inserted into the disclosure.

### DETAILED DESCRIPTION

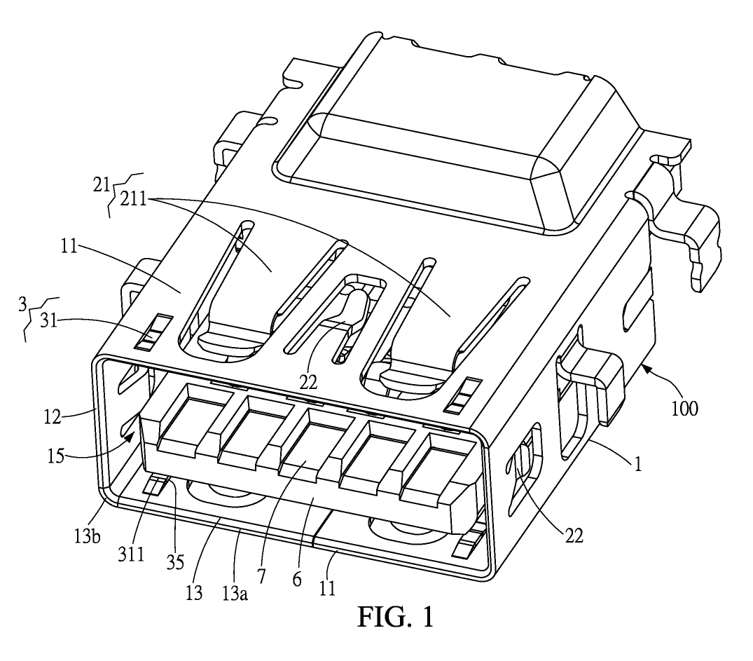

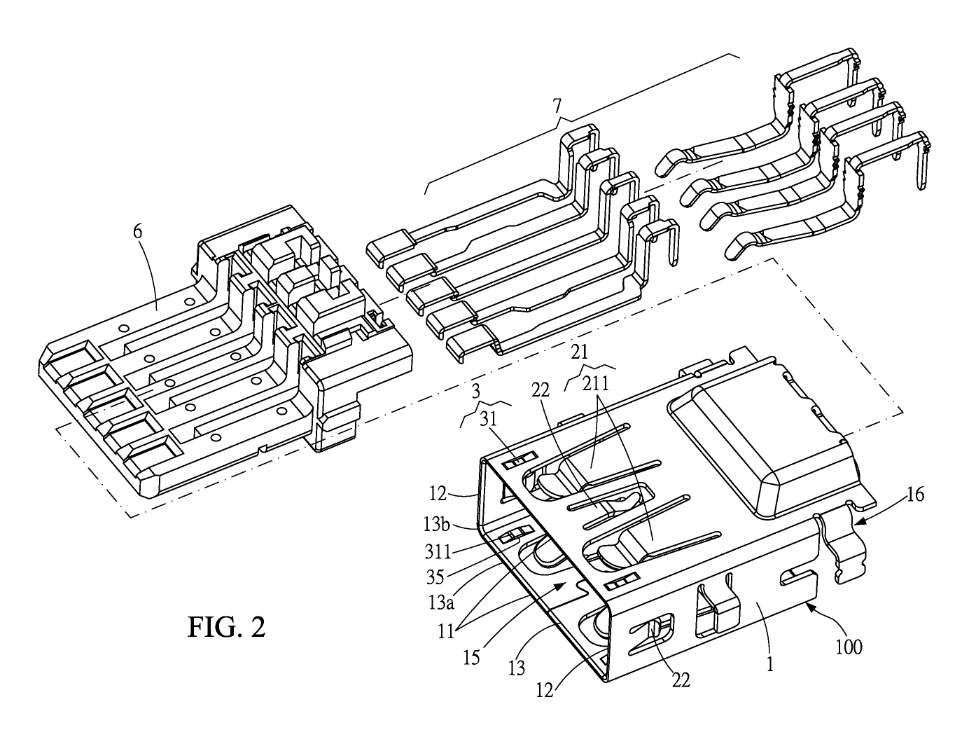

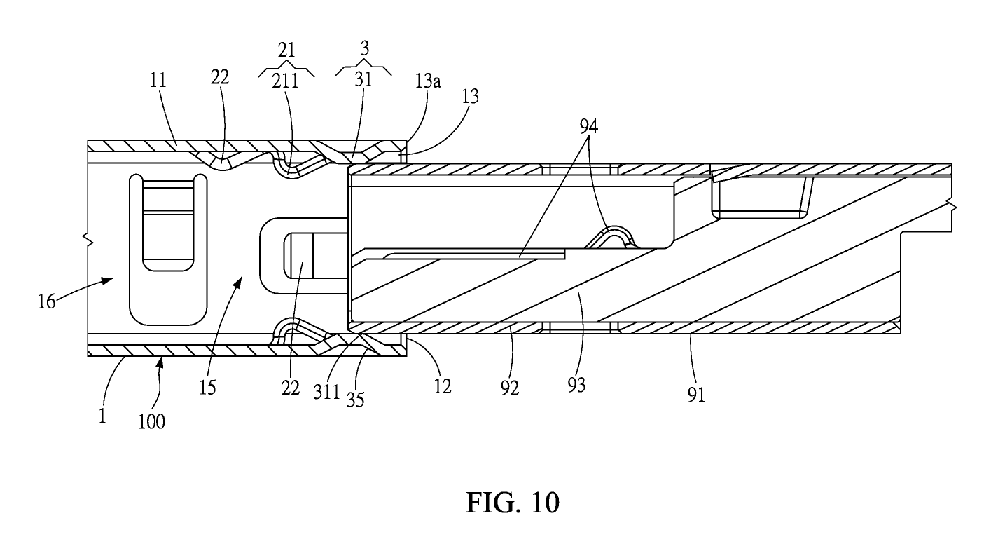

FIG. 1 and FIG. 2 are respectively a perspective view and an exploded view of a receptacle connector 100 of the disclosure. In this embodiment, the receptacle connector 100 is applied for the USB 3.0 interface, but embodiments of the disclosure are not limited thereto; in some implementation aspects, the receptacle connector 100 can be applied for the USB 2.0 interface, the HDMI interface, the Display port interface or the RJ-45 interface. The receptacle connector 100 is provided to be inserted by a plug connector 91 in which the receptacle connector 100 contacts with a casing 92 of the plug connector 91, as shown in FIG. 10.

Please refer to FIGS. 1-2, in which the receptacle connector 100 is substantially consisting of a housing 1, a plurality of elastic pieces 21, a plurality of auxiliary fastening members 3, an insulating base body 6 and a plurality of terminals 7. The insulating base body 6 is an insulating member made of plastic and is disposed in the housing 1. One ends of the terminals 7 are disposed on one plane of the insulating base body 6 and are disposed in an inner side of an inserting window 13 of the housing 1. The terminals 7 are connected with a plurality of sub terminals 94 (not shown), of the plug connector 91.

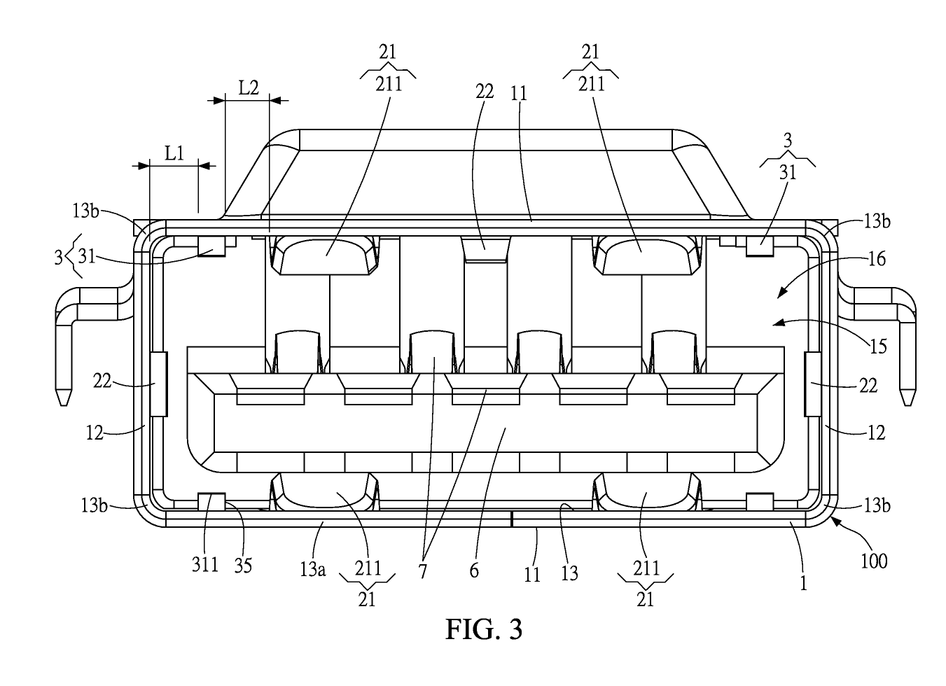

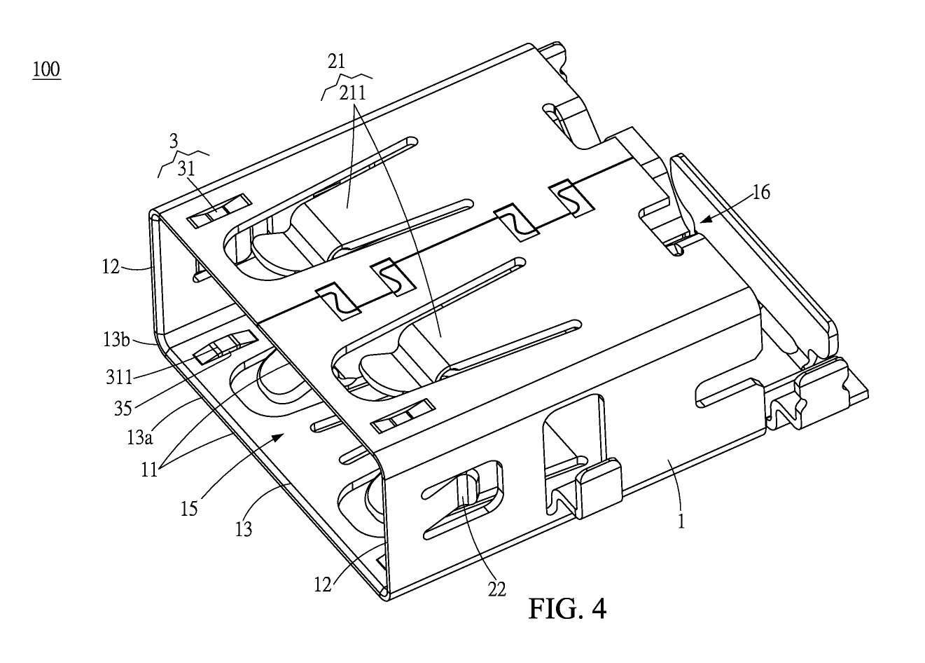

Please refer to FIGS. 3-4, in which the housing 1 is a hollowed body for receiving. A connecting space 15 and a receiving space 16 are formed in the housing 1 in which the connecting space 15 communicates with the receiving space 16. The connecting space 15 matches with the plug connector 91, and the receiving space 16 matches with the insulating base body 6.

Please refer to FIGS. 3-4, in which the housing 1 is substantially consisting of a plurality of first surfaces 11 (namely, the upper surface and the bottom surface), and a plurality of second surfaces 12 (namely, the left surface and the right surface). The second surfaces 12 connected to the two ends of the first surfaces 11. Here, the first surfaces 11 and the second surfaces 12 are combined with each other so as to form the inserting window 13. The size of the inserting window 13 is larger than the size of the plug connector 91, so that the plug connector 91 is capable of inserting into the inserting window 13, as shown in FIG. 10.

Please refer to FIGS. 2-4, in which the elastic pieces 21 are disposed on the first surfaces 11. Here, the elastic pieces 21 are disposed on the two sides of the center regions of the first surfaces 11. Each elastic piece 21 substantially has an elastic arm 211. One ends of the elastic arms 211 are connected to the first surfaces 11, and the other one ends of the elastic arms 211 are extended to the inner side of the inserting window 13 so as to swing elastically and contact with the casing 92 of the plug connector 91. Here, the elastic pieces 21 further have a plurality of auxiliary elastic pieces 22 disposed on the first surfaces 11 and the second surfaces 12.

Please refer to FIGS. 2-4, in which the auxiliary fastening members 3 are disposed on the first surfaces 11. That is to say, the auxiliary fastening members 3 are disposed on the two sides of the first surfaces 11. The auxiliary fastening members 3 can be formed at the four corners of the housing 1 which are adjacent to the inserting window 13.

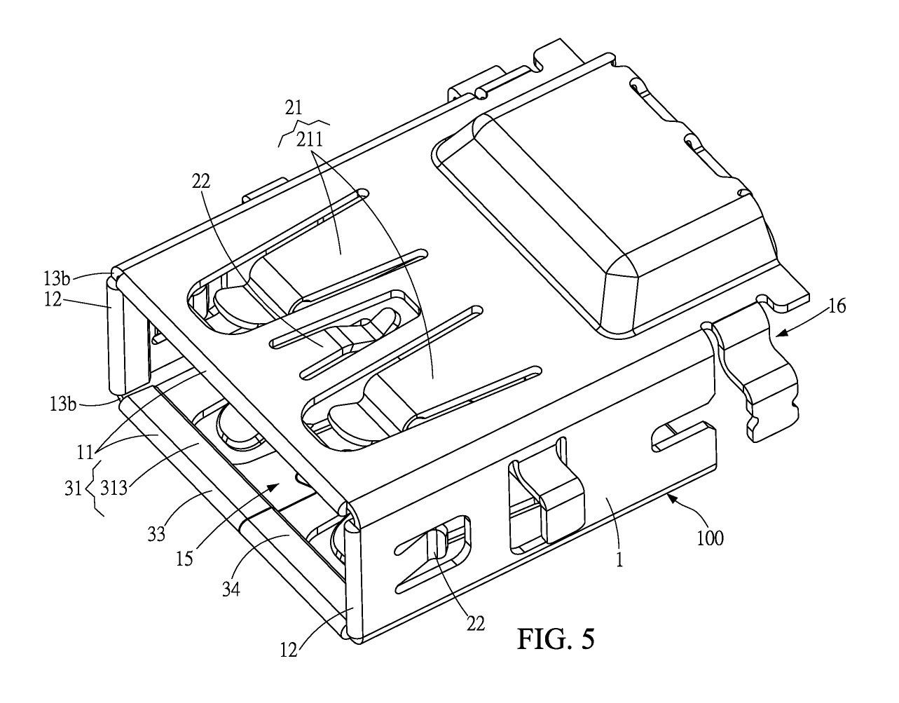

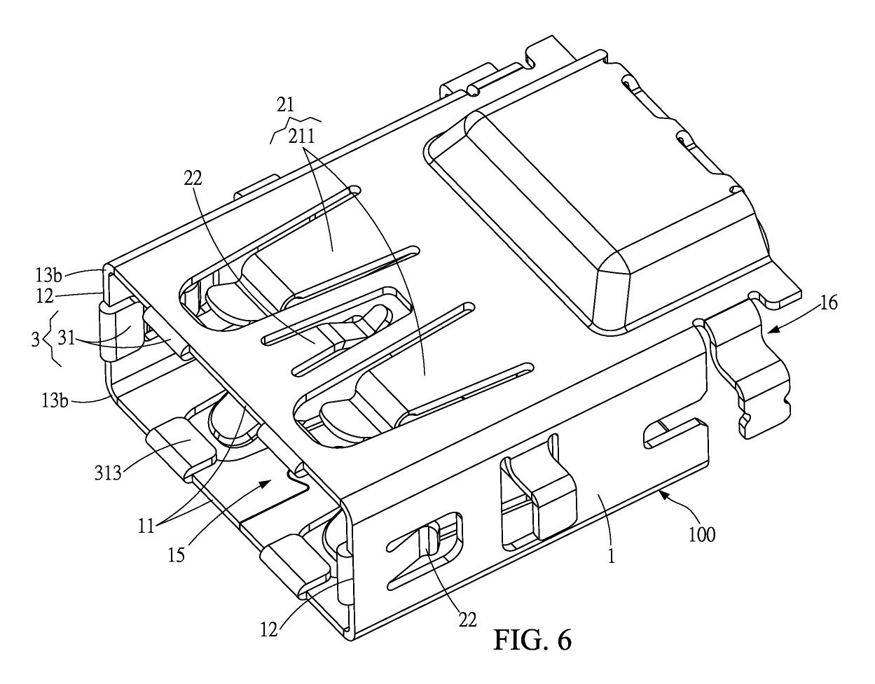

In the embodiment mentioned above, the auxiliary fastening members 3 are disposed on the first surface 11, but embodiments of the disclosure are not limited thereto. In some implementation aspects, the auxiliary fastening members 3 are disposed on the second surfaces 12, as shown in FIGS. 5-6.

Please refer to FIG. 3, in which a first interval L1 is defined between the auxiliary fastening members 3 and the second surfaces 12. The first interval L1 is equal to or larger than 1 millimeter. A second interval L2 is defined between the auxiliary fastening members 3 and the elastic pieces 21. The second interval L2 is equal to or larger than 1 millimeter.

Please refer to FIG. 4, in which each auxiliary fastening member 3 is substantially consisting of a contacting portion 31. The contacting portions 31 are formed extendedly at the inner side of the inserting window 13. That is to say, the contacting portions 31 are formed by extruding the inner faces of the first surfaces 11 toward the inner side of the inserting window 13. The contacting portions 31 can be generated by stamping the first surfaces 11 of the housing 1 and extruding the inner faces of the first surfaces 11 toward the inner side of the inserting window 13.

In the embodiment mentioned above, the contacting portions 31 are formed by extruding the inner faces of the first surfaces 11 toward the inner side of the inserting window 13, but embodiments of the disclosure are not limited thereto. In some implementation aspects, each contacting portion 31 includes a bending segment 33 and an extending segment 34, as shown in FIG. 5. The bending segments 33 are disposed on the flanges 13a of the inserting window 13 (in FIG. 5, the flanges 13a are covered by the bending segments 33). One ends of the extending segments 34 are connected to the bending segments 33, and the other one ends of the extending segments 34 are extended toward the inner side of the inserting window 13; namely, the bending segments 33 and the extending segments 34 are bent to the inner side of the inserting window 13 from the flanges 13a of the inserting window 13.

Additionally, please refer to FIG. 5, in which implementation aspect, one bending segment 33 and one extending segment 34 are formed at each flange 13a of the inserting window 13, but not formed at the turning corners 13b of the inserting window 13; however, in some implementation aspects, bending segments 33 and extending segments 34 are formed at each flange 13a of the inserting window 13. That is to say, a distance is defined between each two adjacent bending segments 33 (or each two adjacent extending segments 34), at each flange 13a. Here, the bending segments 33 and the extending segments 34 are disposed around the flanges 13a of the inserting window 13. In other words, the bending segments 33 and the extending segments 34 are formed at the two sides of the first surfaces 11, as shown in FIG. 6.

Please refer to FIGS. 2-4, in which embodiment, a plurality of elongating segments 35 is formed on the auxiliary fastening members 3 and disposed between the contacting portion 31 and the first surface 11. The elongating segment 35 is manufactured by a tearing process.

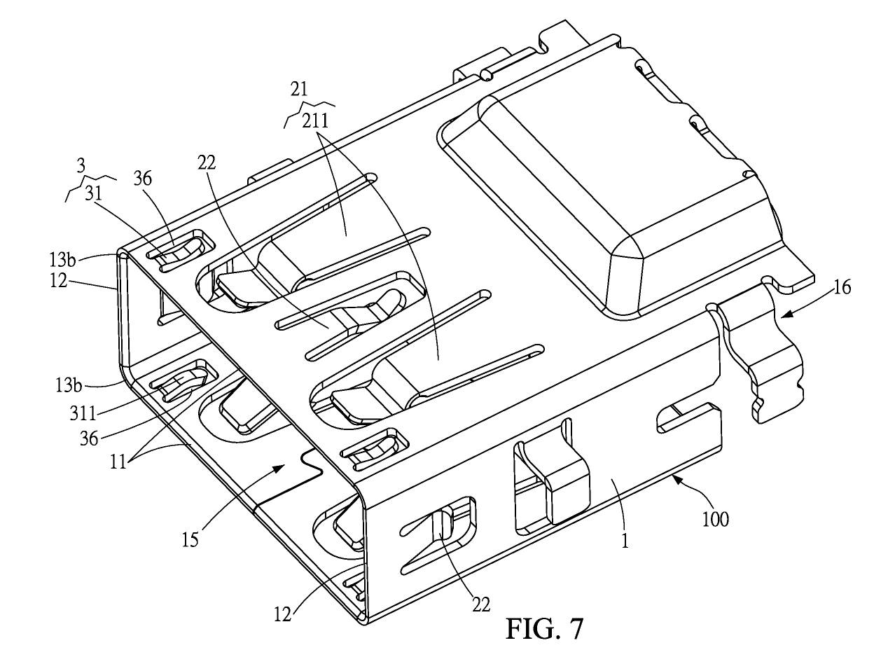

In the embodiment mentioned above, the elongating segments 35 are formed on the auxiliary fastening members 3 by a tearing process, but embodiments of the disclosure are not limited thereto. In some implementation aspects, each auxiliary fastening member 3 has a breach 36 formed thereon and disposed between the contacting portion 31 and the first surface 11, as shown in FIG. 7. The breach 36 is manufactured by feeding process.

Please refer to FIGS. 2-4, in this embodiment, the contacting portions 31 substantially have connecting lines 311. When the contacting portions 31 are contacted with the casing 92 of the plug connector 91, the contacting portions 31 are connected with the surface of the casing 92 by the connecting lines 311 respectively. In this embodiment, a plurality of depths is defined between the connecting lines 311 and the first surfaces 11. Additionally, a sub distance between the depths is smaller or equal to the width of the casing 92 of the plug connector 91 so as to keep the connecting lines 311 to contact with the casing 92.

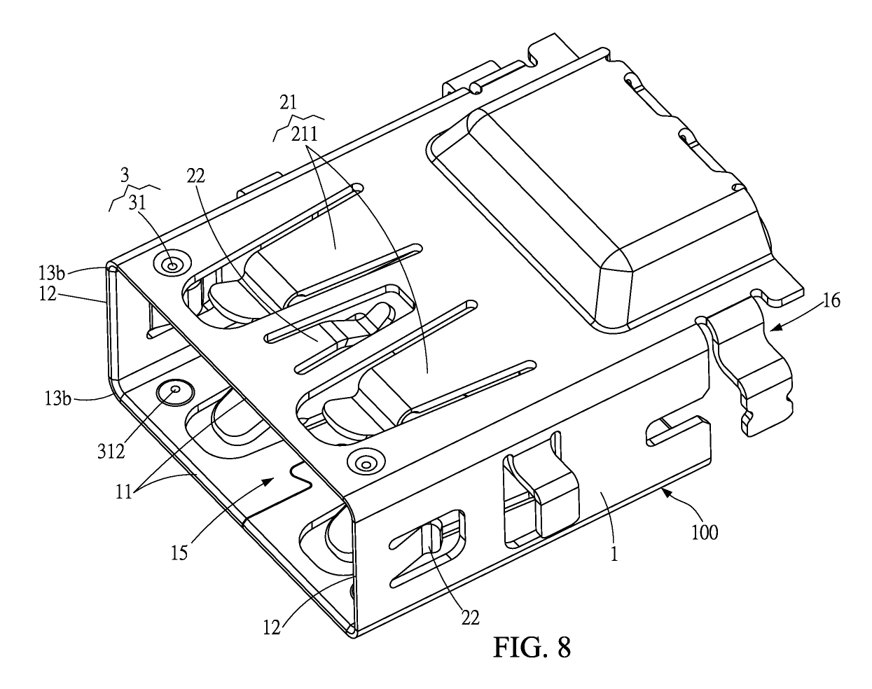

In the embodiment mentioned above, the contacting portions 31 substantially have connecting lines 311 and the contacting portions 31 are connected with the surface of the casing 92 by the connecting lines 311 respectively, but embodiments of the disclosure are not limited thereto. In some implementation aspects, the contacting portions 31 have connecting points 312, as shown in FIG. 8, and the contacting portions 31 are connected with the surface of the casing 92 by the connecting points 312 which are protruded points formed on the contacting portions 31. In addition, in some implementation aspects, the contacting portions 31 have connecting planes 313, as shown in FIGS. 5-6, and the contacting portions 31 are connected with the surface of the casing 92 by the connecting planes 313 so as to increase the contact area between the plug acceptor 91 and the receptacle connector 100 and to reduce the contact resistance between the plug acceptor 91 and the receptacle connector 100.

Table 1 is a testing data sheet for comparing the contact resistance between the plug connector 91 and the receptacle connector 100 with the auxiliary fastening members 3 and the contact resistance between the plug connector 91 and the receptacle connector 100 without the auxiliary fastening members 3. As shown in Table 1, the contact resistance between the plug connector 91 and the receptacle connector 100 without the auxiliary fastening members 3 is larger than the contact resistance between the plug connector 91 and the receptacle connector 100 with four auxiliary fastening members 3. Consequently, the four auxiliary fastening members 3 are capable of reducing the contact resistance between the plug connector 91 and the receptacle connector 100.

TABLE 1

| Contact resistance | |
|---|---|
| (Low level contact resistance, LLCR) | Unit: micro-omega |
| Without the auxiliary fastening members | 10.2 |
| With the auxiliary fastening members | 8.85 |

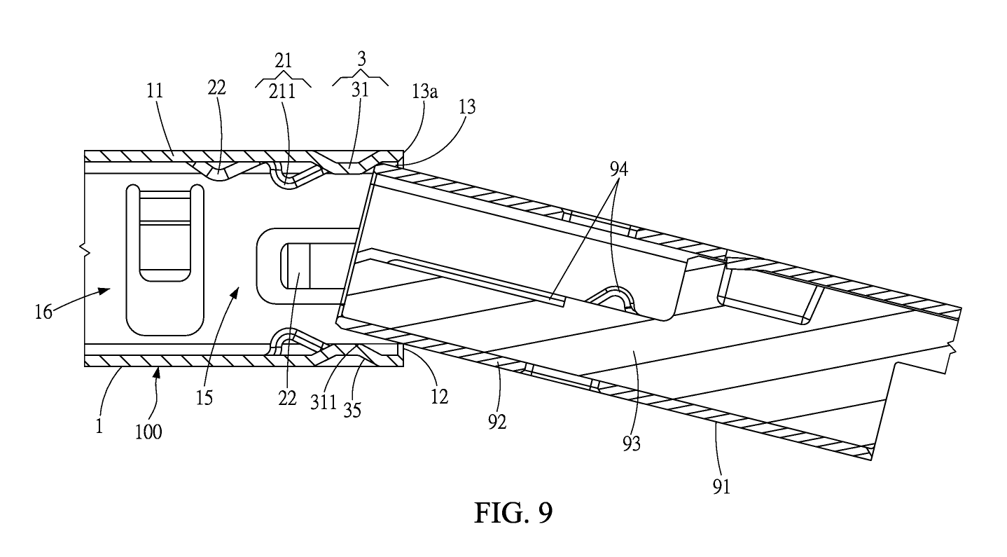

Please refer to FIGS. 9-10, in which when the plug connector 91 is inserted into the housing 1 of the receptacle connector 100, the plug connector 91 is inserted into the housing 1 of the receptacle connector 100 via the inserting window 13. Furthermore, when the contacting portions 31 of the auxiliary fastening members 3 are connected with the surface of the casing 92 of the plug connector 91, the contact area between the casing 92 of the plug connector 91 and the auxiliary fastening members 3 of the receptacle connector 100 can be increased by the contacting portions 31 so as to reduce the contact resistance between the plug connector 91 and the receptacle connector 100. In addition, on the dimension of the electromagnetic interference (EMI), the reducing of the contact resistance causes the reducing of the electromagnetic interference.

Please refer to FIGS. 9-10, in which when the plug connector 91 is inserted into the receptacle connector 100, the plug connector 91 is guided by the contacting portions 31 of the auxiliary fastening members 3, so that the plug connector 91 is inserted into the receptacle connector 100 stably and smoothly. Based on this, the contacting portions 31 of the auxiliary fastening members 3 prevent the elastic pieces 21 of the receptacle connector 100 from damage when the plug connector 91 is abnormally inserted into the receptacle connector 100. Therefore, the receptacle connector 100 of the disclosure has better sustainability and stability upon inserting into/pulling out the plug connector 91.

In the disclosure, the auxiliary fastening members 3 are disposed on the four corners of the inserting window 13 of the housing 1, and the contacting portions 31 of auxiliary fastening members 3 are applied to connect with the surface of the casing 92 of the plug connector 91 so as to increase the contact area, reduce the contact resistance and further decrease the electromagnetic interference of the receptacle connector 100. In addition, the auxiliary fastening members 3 are provided for guiding the inserting orientation of the plug connector 91 so as to prevent the elastic pieces 21 of the receptacle connector 100 from damage when the plug connector 91 is abnormally inserted into the receptacle connector 100, so that the sustainability and the stability of the receptacle connector 100 upon inserting into/pulling out the plug connector 91 are guaranteed.

While the present invention has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A receptacle connector, provided for being inserted by a plug connector and contacted with a casing of the plug connector, comprising:
a housing, comprising:
a plurality of first surfaces; and
a plurality of second surfaces, connected to two ends of the first surfaces so as to form an inserting window;
a plurality of elastic pieces, disposed on the first surfaces; and
a plurality of auxiliary fastening members, disposed on the first surfaces, a first interval defined between the auxiliary fastening members and the second surfaces, a second interval defined between the auxiliary fastening members and the elastic pieces, each auxiliary fastening member comprising a contacting portion, extendedly formed at an inner side of the inserting window;
wherein when the contacting portions are connected with the casing, the contact area between the casing and the auxiliary fastening members can be increased by the contacting portions so as to reduce the contact resistance between the plug connector and the receptacle connector.

2. The receptacle connector according to claim 1, wherein each auxiliary fastening member comprises a breach disposed between the contacting portion and the first surface.

3. The receptacle connector according to claim 1, wherein each auxiliary fastening member comprises an elongating segment disposed between the contacting portion and the first surface.

4. The receptacle connector according to claim 1, wherein each contacting portion comprises a connecting point, each contacting portion is contacted with the casing by the connecting point.

5. The receptacle connector according to claim 1, wherein each contacting portion comprises a connecting line, each contacting portion is contacted with the casing by the connecting line.

6. The receptacle connector according to claim 1, wherein each contacting portion comprises a connecting plane, each contacting portion is contacted with the casing by the connecting plane.

7. The receptacle connector according to claim 1, wherein each contacting portion comprises a bending segment and an extending segment, the bending segment is disposed on flange of the inserting window, the extending segment is connected to the bending segments and extended toward the inner side of the inserting window.

8. The receptacle connector according to claim 1, wherein the auxiliary fastening members are disposed on the second surfaces.

9. The receptacle connector according to claim 1, wherein the elastic pieces further have a plurality of auxiliary elastic pieces disposed on the first surfaces or the second surfaces.

10. The receptacle connector according to claim 1, further comprising an insulating base body, disposed in the housing.

11. The receptacle connector according to claim 10, further comprising a plurality of terminals, disposed on one plane of the insulating base body.
